(19) United States
(12) Patent Application Publication
(10) Pub. No.: US 2019/0034825 A1
(43) Pub. Date: Jan. 31, 2019

(54) AUTOMATICALLY SELECTING REGRESSION TECHNIQUES

(71) Applicant: Microsoft Technology Licensing, LLC, Redmond, WA (US)

(72) Inventors: Wee Hyong TOK, Redmond, WA (US); Yiwen SUN, Bellevue, WA (US); Borna VUKOREPA, Zagreb (HR)

(21) Appl. No.: 15/665,108

(22) Filed: Jul. 31, 2017

(51) Int. Cl. G06N 99/00; G06N 5/04; G06N 7/00

(52) U.S. Cl. CPC G06N 99/005; G06N 7/005; G06N 5/04

(57) ABSTRACT

Estimating and applying effective regression techniques for datasets. The system first applies each of multiple regression techniques to each of multiple reference datasets, and determines a corresponding machine-learning metric for each regression techniques applied to each reference datasets. For each reference datasets, the system uses the determined machine-learning metric to estimate one or more effective regression techniques for execution of the corresponding reference datasets and records the estimated optimal regression techniques and the corresponding reference dataset. A user dataset is compared to at least some of the reference datasets to identify a reference dataset that has an acceptably similar probability distribution to the user dataset. At least one of the optimal regression techniques corresponding to the found reference dataset is retrieved and applied to the user dataset.

### BACKGROUND

In machine learning, regression analysis is used for estimating the relationships among variables of a user dataset. Regression analysis often analyzes the relationship between a response variable (also known as dependent variable) and one or more predictor variables (also known as independent variables). Regression analysis can help one understand how the typical value of a response variable changes when any one of the predictor variables is varied. The estimation target is a function (called a regression function) of the predictor variables. In regression analysis, it is also of interest to characterize the variation of the response variable around the regression function which can be described by a probability distribution.

In machine learning, regression analysis is also used for prediction and forecasting, and to understand which among the predictor variables are related to a response variable, and to explore the forms of these relationships. For instance, if a scientist conducts an experiment to test the impact of a drug on cancer. The predictor variables are the administration of the drug including the dosage and the timing. This is controlled by the experimenting scientists. The response variable, or the variable being affected by the predictor variable, is the impact the drug has on cancer. The predictor variables and response variables can vary from person to person, and the variances are what are being tested; that is whether the people given the drug live longer than the people not given the drug; or the size or severity of the cancer has reduced or progressed slower. The scientist might then conduct further experiments changing other predictor variables such as gender, ethnicity, overall health, etc. in order to evaluate the resulting response variables and to narrow down the effects of the drug on cancer under different circumstances.

Many techniques for carrying out regression analysis in machine learning have been developed. The performance of regression analysis techniques in practice depends on the form of the data generating process, and how it relates to the regression approach being used. Since the true form of data-generating process is generally not known, regression analysis often depends to some extent on making assumptions about this process. Regression models for prediction are fairly accurate when the assumptions are closely followed. Regression models are often still accurate enough to provide useful prediction when the assumptions are moderately violated.

However, when the assumptions are severely violated, regression techniques can give misleading results. When a dataset needs to be analyzed, a user needs to select a regression technique from the available techniques and hyperparameter settings based on the assumption made regarding the dataset. Users are usually experts in a specific area related to the dataset and know what problems they want to solve. For instance, the scientists testing the drug on cancer are experts on biomedical science. However, such users often have limited knowledge of machine learning and/or regression techniques. Finding an optimal or suitable technique and corresponding hyperparameters is often time consuming and requires in depth understanding of machine learning and/or regression techniques.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to estimating effective regression techniques for datasets. Each of multiple regression techniques is applied to each of multiple reference datasets, and a corresponding machine-learning metric is determined for each of the regression techniques applied to each of the reference datasets. For each of the datasets, the determined machine-learning metric is used to estimate one or more of the regression techniques as being effective (e.g., optimal) amongst the multiple regression techniques for machine learning execution of the corresponding reference dataset. The estimated one or more efficient regression techniques and the corresponding reference dataset are recorded in a computer-readable media.

In some embodiments, a user dataset is compared with some of the multiple reference datasets. The act of comparison may include evaluating similarity of probability distribution between the user dataset and the corresponding reference datasets. After comparison, a reference dataset is found to have an acceptably similar probability distribution to the user dataset. The computer-readable media that contains the one or more estimated effective regression techniques corresponding to each of the multiple reference datasets is accessed, and at least one of the one or more estimated effective regression techniques corresponding to the acceptable similar reference dataset is retrieved from the computer-readable media. Finally, the at least one of the one or more estimated effective regression techniques is applied to the user dataset.

Accordingly, the principles described herein allow a user to access an effective regression technique amongst multiple regression techniques to analyze any user dataset, even when the user is not an expert on machine learning or regression techniques or when the form of the data generating process is unknown. Because each regression technique performs differently on different datasets depending on the dataset's generating process and probability distribution, the same regression technique is likely to perform similarly on similar datasets. Since the system finds a reference dataset that is acceptably similar to the user dataset, the estimated effective regression techniques that performs effectively on the reference dataset is likely to perform effectively on the user dataset.

The principles described herein also avoid a time-consuming process that a user traditionally goes through to find an effective regression technique. Traditionally, to find an effective regression technique for a user dataset, of which the data generating process or the probability distribution is unknown, the user applies multiple regression techniques to the user dataset to find out which one of the multiple regression techniques is more effective. Applying multiple regression techniques to the user dataset is very time consuming. Here, the multiple reference datasets have been analyzed using the multiple regression techniques, and the result of such analysis have been stored in a computer-readable media beforehand. Therefore, when a user dataset is analyzed, the system only needs to compare the user dataset and some of the reference datasets. The comparison process is a much faster process than applying multiple regression techniques to the user dataset.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates an environment that includes an estimation component, a selection component, and a dataset, and may also include an optimization component;

FIG. 3 illustrates an environment that may be implemented by the estimation component of FIG. 2;

FIG. 4 illustrates an environment that may be implemented by the selection component of FIG. 2;

FIG. 5 illustrates a chart of an example Skyline Query, in which each data point represents a different regression technique, and the solid line represents a skyline of the data points;

FIG. 6A illustrates a result of Kullback-Leibler (KL) divergence for comparing two datasets that have very similar distributions;

FIG. 6B illustrates a result of Kullback-Leibler (KL) divergence for comparing two datasets that have slightly dissimilar distributions;

FIG. 7 illustrates a flowchart of a method for determining effective regression techniques for reference datasets; and

FIG. 8 illustrates a flowchart of a method for choosing effective regression techniques for a user dataset.

### DETAILED DESCRIPTION

At least some embodiments described herein relate to estimating effective regression techniques for datasets. Each of multiple regression techniques is applied to each of multiple reference datasets, and a corresponding machine-learning metric is determined for each of the regression techniques applied to each of the reference datasets. For each of the datasets, the determined machine-learning metric is used to estimate one or more of the regression techniques as being effective (e.g., optimal) amongst the multiple regression techniques for machine learning execution of the corresponding reference dataset. The estimated one or more effective regression techniques and the corresponding reference dataset are recorded in a computer-readable media.

In some embodiments, a user dataset is compared with some of the multiple reference datasets. The act of comparison may include evaluating similarity of probability distribution between the user dataset and the corresponding reference datasets. After comparison, a reference dataset is found to have an acceptably similar probability distribution to the user dataset. The computer-readable media that contains the one or more estimated effective regression techniques corresponding to each of the multiple reference datasets is accessed, and at least one of the one or more estimated effective regression techniques corresponding to the acceptable similar reference dataset is retrieved from the computer-readable media. Finally, the at least one of the one or more estimated effective regression techniques is applied to the user dataset.

Accordingly, the principles described herein allow a user to access an effective regression technique amongst multiple regression techniques to analyze any user dataset, even when the user is not an expert on machine learning or regression techniques or when the form of the data generating process is unknown. Because each regression technique performs differently on different datasets depending on the dataset's generating process and probability distribution, the same regression technique is likely to perform similarly on similar datasets. Since the system finds a reference dataset that is acceptably similar to the user dataset, the estimated effective regression techniques that performs effectively on the reference dataset is likely to perform effectively on the user dataset.

The principles described herein also avoid a time-consuming process that a user traditionally goes through to find an effective regression technique. Traditionally, to find an effective regression technique for a user dataset, of which the data generating process or the probability distribution is unknown, the user applies multiple regression techniques to the user dataset to find out which one of the multiple regression techniques is more effective. Applying multiple regression techniques to the user dataset is very time consuming. Here, the multiple reference datasets have been analyzed using the multiple regression techniques, and the result of such analysis have been stored in a computer-readable media beforehand. Therefore, when a user dataset is analyzed, the system only needs to compare the user dataset and some of the reference datasets. The comparison process is a much faster process than applying multiple regression techniques to the user dataset.

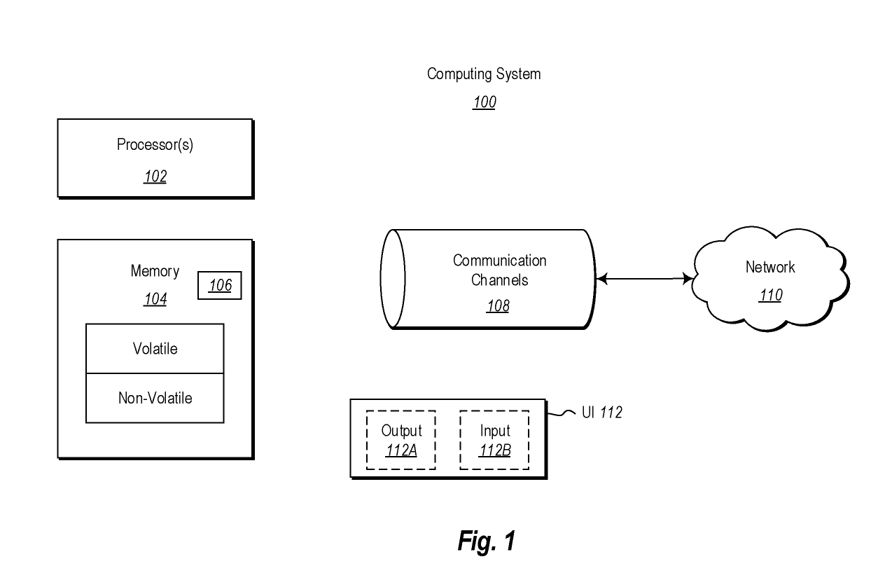

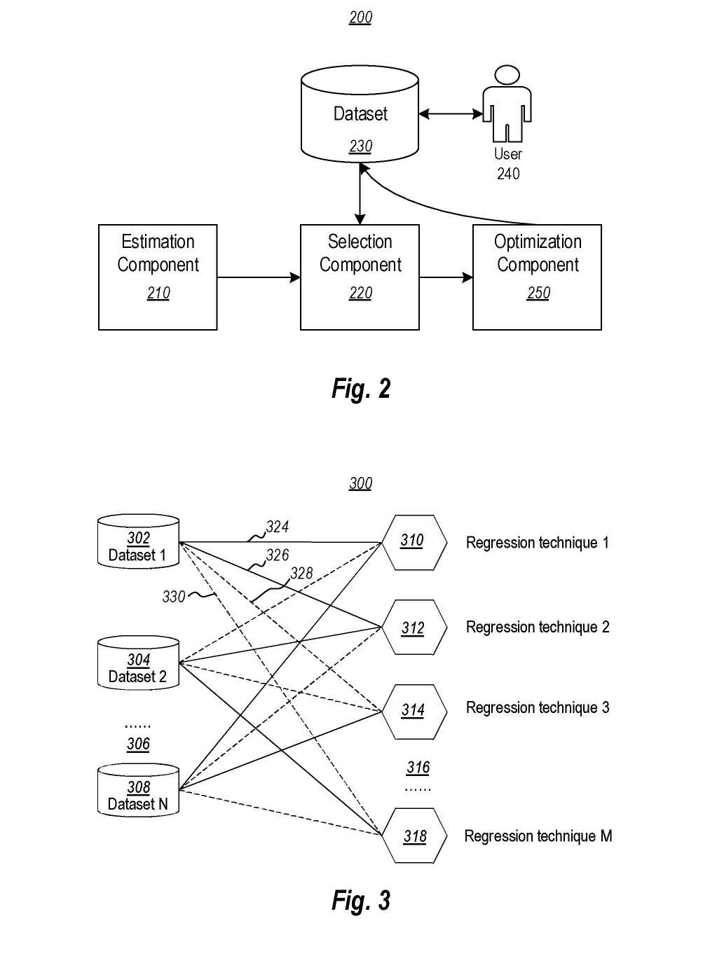

Because the principles described herein operate in the context of a computing system, a computing system will be described with respect to FIG. 1. Then, the principles of determining when to perform regression performance analysis based on query performance metrics will be described with respect to FIGS. 2 through 8.

Computing systems are now increasingly taking a wide variety of forms. Computing systems may, for instance, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the term “component” or “vertex” may also be used. As used in this description and in the case, this term (regardless of whether the term is modified with one or more modifiers) is also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For instance, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for instance, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms, virtual reality, and so forth. Examples of input mechanisms 112B might include, for instance, microphones, touchscreens, holograms, virtual reality, cameras, keyboards, mouse of other pointer input, sensors of any type, and so forth.

Embodiments described herein may comprise or utilize a special purpose or general-purpose computing system including computer hardware, such as, for instance, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or components and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For instance, computer-executable instructions or data structures received over a network or data link can be buffered in RAM within a network interface component (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for instance, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for instance, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program components may be located in both local and remote memory storage devices.

Those skilled in the art will also appreciate that the invention may be practiced in a cloud computing environment, which is supported by one or more datacenters or portions thereof. Cloud computing environments may be distributed, although this is not required. When distributed, cloud computing environments may be distributed internationally within an organization and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand, self-service, broad network access, resource pooling, rapid elasticity, measured service, and so forth. A cloud computing model may also come in the form of various application service models such as, for instance, Software as a service (“SaaS”), Platform as a service (“PaaS”), and Infrastructure as a service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

FIG. 2 shows an environment 200 that includes an estimation component 210, a selection component 220, and a dataset 230. When a user 240 initiates a machine learning process for dataset 230, the selection component 220 analyzes the dataset 230 (called hereinafter a “user dataset”), retrieves at least one estimated effective regression technique from the estimation component 210, and applies the retrieved effective regression technique to the dataset 230. The environment 200 may also include an optimization component 250.

An example each of the components 210, 220, 250 may be a computing system such as the computing system 100 of FIG. 1, or an executable component 106 running on that computing system 100. Likewise, the dataset 230 may also operate with the assistance of a computing system such as the computing system 100 of FIG. 1. The estimation component 210 and the selection component 220 may, but need not, be remote from each other. As an example, the estimation component 210 may be a cloud computing service, whereas the selection component 220 may be executed at a customer site that is served by the cloud computing service. The estimation component 210 includes the estimated effective regression techniques for multiple reference datasets.

In the case where the environment 200 further include an optimization component 250, after the selection component 220 retrieves an estimated effective regression technique, the selection component 220 may send the retrieved effective regression technique to the optimization component 250. The optimization component 250 adjusts one or more hyperparameters of the retrieved regression technique, and then applies the optimized regression technique to the dataset 230.

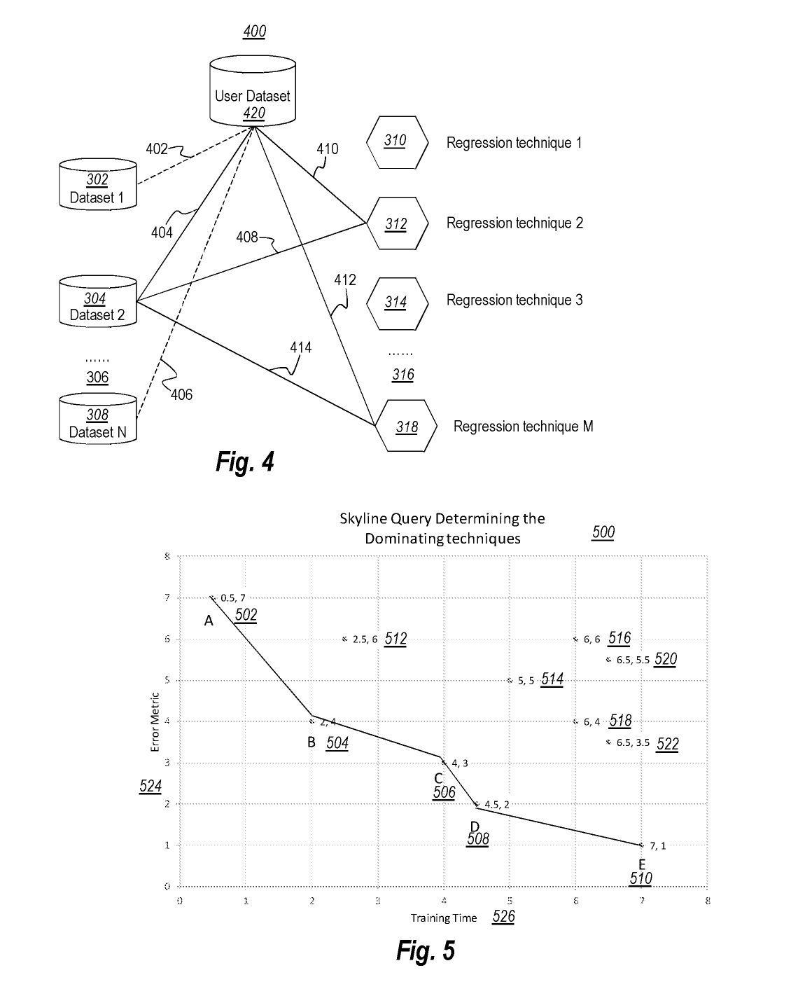

FIG. 3 illustrates an environment 300 that may be implemented by the estimation component 210 of FIG. 2. In the environment 300, multiple reference datasets 302, 304 and 308 are analyzed via multiple regression techniques 310, 312, 314 and 318 for determining one or more effective regression techniques for each of the reference datasets. FIG. 4 illustrates an environment 400 that may be implemented by the selection component 220 of FIG. 2. In the environment 400, a user dataset 320 is compared for similarity against the reference datasets 302, 304 and 308, and at least one estimated effective regression technique is retrieved and applied to the user dataset 320.

Returning to FIG. 3, in the environment 300, multiple reference datasets 302, 304 and 308 are analyzed via multiple regression techniques 310, 312, 314 and 318 for determining one or more effective regression techniques for each of the reference datasets. In FIG. 3, dataset 1 302, dataset 2 304 and dataset N 308 represent multiple reference datasets. The ellipsis 306 and the letter “N” represent that there may be any whole number (N) of reference datasets accessible by the system. The N reference datasets may hereinafter be collectively referred to as “reference datasets 302 to 308”. For instance, the reference datasets may be representative datasets from University of California at Irvine (UCI)'s Machine Learning Repository. Currently, UCI maintains more than 300 datasets as a service to the machine learning community, so that researchers and scientists can use these datasets to test their regression techniques or other machine learning techniques.

There are many regression techniques that can be used to model the relationship between variables in a dataset, including but not limited to Ordinary Least Squares Regression (OLSR), Model Tree Regression, Lasso Regression, Ridge Regression, Elastic Net Regression, Regression Tree, Random Forest Regression, Passive-Aggressive Regression, Stochastic Gradient Descent Regression, amongst many others. As illustrated in FIG. 3, regression technique 1 310, regression technique 2 312, regression technique 3 314, and regression technique M 218 represent multiple regression techniques. The ellipsis 316 and the letter M represent that there may be any whole number (M) of regression techniques in the list. The M regression techniques may hereinafter be collectively referred to as “regression techniques 310 to 318”.

The performance of each regression techniques 310 to 318 in practice depends on the form of data generating process. However, the true form of data-generating process is generally not known. One way of finding out a suitable or optimal regression technique for a particular dataset is to analyze the dataset using each of the regression techniques 310 to 318. The performance of each regression techniques 310 to 318 may be measured by machine-learning metric. The machine-learning metric may include multiple considerations (i.e., may be calculated using different input parameters). As an example only, the machine-learning metric may be determined from any one or more of machine-learning training time, accuracy, resource usage, explainability and simplicity. When multiple considerations are included in the machine-learning metric, the machine-learning metric becomes a multi-dimensional measurement, which may be represented by an array.

As illustrated in FIG. 3, each of the reference datasets 302 to 308 is analyzed by each of the regression techniques 310 to 318. For instance, dataset 1 302 is analyzed using each of the regression techniques 310 to 318; dataset 2 304 and dataset N 308 (and potentially other reference datasets that are represented by the ellipses 306) are also each analyzed using each of the regression techniques 310 to 318. Each of the solid lines and dotted lines connecting a reference dataset and a regression technique represents the application of a corresponding regression technique (at one end of the line) to a corresponding reference datasets (at the other end of the line).

In the illustrated example of FIG. 3, all regression techniques 310 to 318 are applied against all reference datasets 302 to 308. However, that is for illustrative purposes only. In other embodiments, perhaps only a subset (one or more) of the regression techniques are applied against a reference dataset. As an example, it may be know that certain regression techniques are not well suited to certain types of datasets. In that case, rather than futility testing the machine learning metric for that regression technique against the mismatched reference dataset, the regression technique may be skilled for that reference dataset.

The act of applying each of the regression techniques 310 to 318 to each of the datasets 302 to 308 returns a corresponding result (e.g., array) of the machine-learning metric. For instance, applying each of the M regression techniques 310 to 318 to dataset 1 302, the system returns a corresponding machine-learning metric for each of the M regression techniques.

The system may analyze or sort the M sets of machine learning efficiencies to estimate one or more effective (e.g., optimal) regression techniques for each of the referenced datasets. For instance, for dataset 302, as illustrated, the solid lines 324 and 326 represent that the regression techniques 310 and 312 are estimated as effective regression techniques for the dataset 302. The dotted lines 328 and 330 represent that the regression techniques 314 and 318 are estimated as not effective regression techniques for the dataset 302.

Similarly, the system applies each of the regression techniques 310 to 318 to the reference datasets 304, 306 and 308. For instance, applying each of the regression techniques 310 to 318 to reference dataset 2 304, the analysis returns another M sets of machine-learning efficiencies; and applying each of the regression techniques 310 to 318 to reference dataset N 306, the analysis returns another M set of machine-learning efficiencies. In this example, for each of the reference datasets 302 to 308, the analysis returns M sets of machine-learning efficiencies.

Also, similarly, the system analyzes each M sets of the machine-learning efficiencies to estimate one or more effective regression techniques corresponding to each of the reference dataset. As illustrated, the solid lines between a reference dataset (at one end of the line) and a regression technique (at the other end of the line) represent the estimated effective techniques corresponding to the reference dataset. For instance, for dataset 1 302, the estimated effective regression techniques are regression technique 1 310 and regression technique 2 312; for dataset 2 304, the estimated effective regression techniques are regression technique 2 312 and regression technique M 318; and for dataset N, the estimated effective regression techniques are regression technique 1 310 and regression technique 3 314.

There are many ways to analyze each M set of machine-learning efficiencies for estimating effective regression techniques corresponding to each reference dataset. The computing system may preset a sorting method, or a user may choose his/her preferred sorting method. In one embodiment, the values of one of the considerations of the machine-learning efficiencies may be sorted. For instance, when the only consideration that a user cares about is accuracy, the system may select the top several regression techniques that have the highest accuracy. Similarly, when the only consideration that a user cares about is training time, the system may select the top several regression techniques that have the lowest training times.

In another embodiment, when more than one considerations of the machine-learning metric are relevant to the user, multi-dimensional queries may be used to determine one or more dominating regression techniques. In one embodiment, the values of more than one considerations of the machine-learning metric may be summed together. In another embodiment, the values of more than one consideration of the machine-learning metric may be given different weights before being summed together.

For instance, a system may include two considerations of machine-learning metric, training time and accuracy. In general, the shorter the training time and the lower the error metric, the better the regression technique is. Therefore, if there is one regression technique that has the lowest training time and the lowest error metric, it would be apparent that such a regression technique is the best regression technique. However, most of the time, the machine-learning efficiencies of different regression techniques are better at some considerations, but worse at other considerations. Therefore, there is not a regression technique that is absolutely better than the others. In such cases, multi-dimensional queries may be used to determine dominating regression techniques amongst the list of the regression techniques. A Skyline query is one of the multi-dimensional queries that may be used to determine an effective regression technique or dominating regression technique.

FIG. 5 illustrates a chart 500 of Skyline Query, in which each of the data points 502, 504, 506, 508, 510, 512, 514, 516, 518, 520, and 522 represents a machine-learning metric of a different regression technique that is applied to a particular reference dataset. Each data point represents the machine-learning metric of a different regression technique, and two axes represent two considerations of the machine-learning metric. For instance, the horizontal axis represents training time 526; and the vertical axis represents error metric 524. Data point A 502 is placed at point (0.5, 7) on the chart 500, which represents a regression technique that has a training time of 0.5 and error metric of 7; data point B 504 is placed at point (2, 4) on the chart 500, which represents a regression technique that has a training time of 2 and error metric of 4. Similarly, each of the points 506, 508, 510, 512, 514, 516, 518, 520, and 522 each represents a corresponding regression technique that has a training time of the value along the horizontal axis and an error metric of the value along the vertical axis. The data points 502, 504, 506, 508, 510, 512, 514, 516, 518, 520, and 522 may hereinafter be collectively referred to as “data points 502 to 522.”

A Skyline query is a query that returns an output set of points (skyline a points) (e.g., points A 520, B 504, C 506, D 508 and E 510) given an input set of points (e.g., data points 502 to 522), such that any of the skyline points (e.g., A 520, B 504, C 506, D 508 and E 510) is not dominated by any other point. A point dominates another point if and only if the coordinate of the dominating point on any axis is not larger than the corresponding coordinate of the dominated point.

For instance, data point A 502 is located at point (0.5, 7); data point B 504 is located at point (2, 4). Because data point A 502's training time axis value 0.5 is smaller than data point B 504's training time axis value 2, data point B 504 is not dominated by data point A 502. On the other hand, because data point B 504's error metric axis value 4 is smaller than data point A 502's error metric value 7, data point A 502 also is not dominated by data point B 504. Accordingly, data point A 502 and data point B 504 are mutually not dominated by each other. In such a circumstance, neither the regression technique represented by data point A 502 nor the regression technique represented by data point B 504 is better, because when a user prefers a faster training time, he/she would prefer the regression technique represented by data point A 502, when a user prefers a more accurate prediction, he/she would prefer the regression technique represented by data point B 504.

As another example, each of the axes' values of data point B 504 is smaller than each of the corresponding axes' values of data point 512. Accordingly, data point B 502 dominates data point 512, and data point 512 does not dominate data point B 502. Therefore, the regression technique represented by data point B 504 is better than the regression technique represented by data point 512, because the regression technique represented by data point B 502 has both lower training time and lower error metric compared to the regression technique represented by data point 512.

As illustrated in FIG. 5, point A (0.5, 7) 502 has the lowest time value than all other points, therefore, point A is not dominated by any of other points 504 to 522; point B (2, 4) 504 has a lower error metric value than the points 502, 512 to 520 that are above it on the chart 500, and has a lower time value than all the points 506 to 510, and 522 that are below it on the chart 500; similarly, points C 506 or D 508 also has a lower error metric value than all the points that are above it, and has a lower time value than all the points that are below it; and point E 510 has the lowest error metric value than all other points 502 to 508, 512 to 522. Accordingly, the points A 502, B 504, C 506, D 508 and E 510 are the skyline points, which are not dominated by any of the points on the chart, and the regression techniques represented by points A 502, B 504, C 506, D 508, and E 510 are the “dominating regression techniques” for the particular reference dataset. Connecting the skyline points A 502, B 504, C 506, D 508, and E 510 would create a “skyline”.

FIG. 5 illustrates a 2-dimension skyline query that includes two considerations of the machine-learning metric. The two considerations of the machine-learning metric are training time 526 and error metric 524. However, the method disclosed here may include more than just error metric and training time as the considerations of machine-learning efficiencies, such that the skyline query may be a 3-dimensional (3D) query or even a higher dimensional query. For instance, other considerations may be included in the machine-learning metric, but are not limited to, resource usage, explainability and simplicity.

Many practical applications of machine learning systems call for the ability to explain why certain predictions are made. For instance, in a fraud detection system, it is not very useful for a user to see multiple possible fraud attempts without any explanation why the system thought the attempt was fraud. A user would prefer a system to say something like “the system thinks it's fraud because the credit card was used to make several transactions that are larger than usual.”

Simplicity of the technique is also important. If the performance is about the same, the simpler the technique, the better it is. Simplicity may be related to explainability and resource usage. Generally, the simpler the technique, the easier to explain it, and/or the less resources the process would take, therefore, be more desirable. The system or the user may also define other considerations that may be important to the user as considerations of machine-learning metric.

A Skyline query is only one example of multi-dimensional queries that may be used to determine the dominating or effective regression techniques. Other multi-dimensional queries could also be applied to more than two considerations of machine-learning efficiencies for determining one or more effective regression techniques. The user may indicate a preferred multi-dimensional query that is to be applied to determine the effective regression techniques. Alternatively, the system may automatically select a multi-dimensional query for a particular reference dataset, a particular user dataset or a particular user.

Returning to FIG. 4, FIG. 4 illustrates an environment 400 in which a user dataset 320 is compared for similarity against the reference datasets 302, 304 and 308 for finding a reference dataset that is acceptably similar to the user dataset 320. After a determination that a reference dataset is acceptably similar to the user dataset 320, at least one of the effective regression techniques for the acceptably similar reference dataset is retrieved and applied to the user dataset 320.

In FIG. 4, dataset 1 302, dataset 2 304 and dataset N 308 represent the same reference datasets illustrated in FIG. 3. Similarly, regression technique 1 310, regression technique 2 312, regression technique 3 314, and regression technique M 318 represent the same regression techniques illustrated in FIG. 3.

As illustrated in FIG. 4, the user dataset 320 is compared to some of the datasets 302 to 308. After comparing the user dataset 320 with some of the reference datasets 302 to 308, an acceptable similar reference dataset compared to the user dataset 320 is found. The solid line and doted lines between user dataset 320 and each of the reference datasets 302 to 308 represents the act of comparison. The solid line between the user dataset 320 and dataset 2 304 represents that dataset 2 304 is the acceptably similar reference dataset (at one end of the line) to the user dataset 320 (at the other end of the line) among the reference datasets 302 to 308. The doted lines between the user dataset 320 and dataset 1 302 and dataset N 308 represents that datasets 1 302 and dataset N 308 (at one end of the line) are not acceptably similar to the user dataset 320 (at the other end of the line).

After determining the acceptably similar reference datasets to the user dataset 320, at least one of the estimated effective techniques corresponding to the determined acceptably similar reference dataset is retrieved and applied to the user dataset 320. For instance, as illustrated in FIG. 4, dataset 2 304 is found to be the acceptably similar dataset to the user dataset 320. The effective techniques for dataset 2 304 are regression technique 2 312 and regression technique N 318, as illustrated in FIG. 3. Accordingly, at least one of regression technique 2 302 and regression technique N 308 is applied to the user dataset 320.

Generally, the more similar the user dataset to the reference dataset, the more effective or better the estimated effective regression techniques would apply to the user dataset. Also, the more reference datasets that the user dataset is compared to, the more likely the comparison would return the most similar reference dataset. However, the user often does not have enough time to compare the user dataset against each of the reference datasets. In such cases, the user may indicate the minimum acceptable similarity between the user dataset and the corresponding reference dataset; and the computing system would finish the act of comparison whenever an acceptable similar reference dataset is found. Or the user may indicate a maximum time for the machine-learning process, and the computing system may allocate a portion of the maximum time allowed to the act of comparison and returns a most similar reference dataset within the allowed time frame.

In some other embodiments, the system may also store each of the machine-learning metric corresponding to each of the reference dataset and each of the regression techniques in the database. The system may determine one or more effective regression techniques based on a user's indications. For instance, when a user prefers a faster training time, he may weigh the training time as a more important consideration based on the recorded machine-learning efficiencies. Then, the system may customize a particular multi-dimensional query that returns one or more effective regression techniques that have faster training time, and also sufficiently accurate, or based on user's indication of preference.

Traditionally, when a user needs to analyze a user dataset 320, the user needs to make an assumption of the data-generating process of the user dataset 320. Since users often are not experts on regression technics, they may make wrong or inaccurate assumptions. If the assumption is severely violated, the chosen regression technique may give misleading results. Alternatively, the user may analyze the user dataset via multiple regression techniques to determine the suitable or effective one, which is time consuming.

Here, the user does not need to make an assumption of the data-generating process of the user dataset 320 or applies multiple regression techniques to the user dataset 320 to find out the effective techniques. The computing system(s) automatically compares the user dataset to some of the reference datasets 310 to 318, find an acceptably similar reference dataset to the user dataset 320, and retrieves one of the estimated effective regression techniques for applying to the user dataset. The time used on comparing datasets is much less than applying multiple regression algorithms to the user dataset.

Regarding to comparing the user dataset and a reference dataset, there are many methods of doing it. In some embodiments, the system(s) may compare the probability distribution of the user dataset and the corresponding reference dataset. There are also many methods can be used to compare two datasets' probability distributions, which include but are not limited to Kullback-Leibler (KL) divergence and Jensen-Shannon (JS) divergence.

In some embodiments, KL divergence is used to determine the similarity of two datasets. KL divergence is a measure of how one probability distribution diverges from a second expected probability distribution. In the simple case, KL divergence 0 indicates that we can expect similar or the same of behavior of two different distributions; and KL divergence 1 indicates that the two distributions behave in such a different manner that the expectation given the first distribution approaches zero. The KL divergence from a continuous probability distribution Q to another continuous probability distribution P is often denoted D_{KL}(P|Q). If p and q are corresponding probably density functions of P and Q, KL divergence is defined as:

$${D}_{KL} ( P \vert Q ) = {\int }_{- ∞}^{+ ∞} p ( x ) log ( \frac{p ( x )}{q ( x )} ) dx \qquad ( 1 )$$

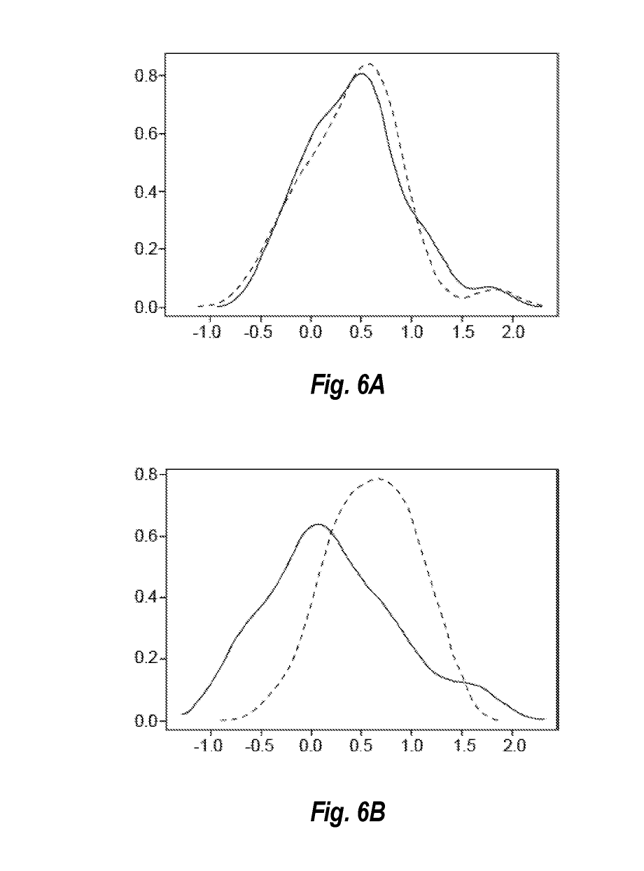

The formula (1) indicates that KL divergence is always between 0 and 1. When the value is close to 0, two distributions in question are almost the same. When the value is close to 1, the two distributions in question are completely different. For instance, as illustrated in FIG. 6A, the two distributions are very similar. Therefore, the KL divergence of the two distributions in FIG. 6A is 0.02, which is close to 0. In another example, as illustrated in FIG. 6B, the two distributions are not as similar as the two distributions in FIG. 4A. Therefore, the KL divergence of the two distributions in FIG. 6B is 0.384.

For instance, if the comparison component 220 illustrated in environment 400 compares two of the reference datasets 310 to 318, and returns two KL divergences as illustrated in FIGS. 6A and 6B, the corresponding reference dataset illustrated in FIG. 6A would likely be selected as an acceptably similar reference dataset against the user dataset 320, because the KL divergence of the comparison illustrated in FIG. 6A is much smaller than the KL divergence of the comparison illustrated in FIG. 6B, and the corresponding dataset illustrated in FIG. 6A is much more similar to the user dataset 320 than the corresponding dataset illustrated in FIG. 6B.

Additionally, since each of the datasets may include a different number of columns and each column of data may have different correlation with other columns, the system may choose to compare only the first several most informative columns of the reference dataset and the user dataset 320. To determine which columns are more informative, the system may analyze the corresponding reference dataset and the user dataset to determine the coefficient of each predictor variable to a response variable. A predictor variable is also called independent variable. A predictor variable is used to predict a response variable (also known as dependent variable). These coefficients are then ranked to determine the most informative predictor variables and response variables.

The computing system(s) may choose (or the user may determine) to use the top several pairs of predictor variable and response variable that receive the highest correlation coefficient value as the most informative columns. Then the system may apply the similarity determination to these top several predictor variable columns and response columns of the user dataset and the corresponding reference dataset.

In some embodiment, after selecting the top several pairs of predictor variables and response variables, the probability distribution of the most informative columns of the user dataset and the most informative columns of the corresponding reference dataset are estimated. And each of the estimated probability distribution of the user dataset and each of the estimated probability distribution of the corresponding reference dataset are compared to each other, and a similarity score is generated corresponding to each of the comparisons.

In some embodiment, each of the similarity scores may be summed together as a total similarity score. Alternatively, each of the similarity scores based on the pre-determined correlation coefficient value of the columns may be weighed based on importance, correlation coefficient or any other criteria, then summed together as the total similarity score. An acceptably similar reference dataset against the user dataset may then be determined based on the total similarity score.

In some other embodiments, the system may also consider the similarity of the dataset size or other factors of the datasets between the user dataset and the corresponding reference dataset, and incorporate such information into a final similarity score. Given a particular user dataset, the reference dataset that returns the best final similarity score may be determined as the acceptably similar reference dataset to the user dataset. Alternatively, a user may indicate the minimum acceptable similarity score, and the system would stop comparing once a reference dataset returns an acceptable similarity score.

Determining the coefficient of each predictor variable to a response variable may be completed via a correlation coefficient method. A correlation coefficient is a number that quantifies a type of correlation and dependence, i.e., statistical relationships between one or more values in fundamental statistics. Types of correlation coefficients include but are not limited to Spearman's rank correlation coefficient, Pearson product-moment correlation coefficient, intraclass correlation, Kendall tau rank correlation coefficient, and Goodman and Kruskal's gamma.

In some embodiments, the system compares the user dataset to each of the some of the plurality of reference datasets via Pearson correlation coefficient. Pearson correlation coefficient is a measure of the linear correlation between two variables X and Y. Pearson correlation has a value between +1 and −1, where 1 is total positive linear correlation, 0 is no linear correlation, and −1 is total negative linear correlation.

In some embodiments, the system compares the user dataset to each of the some of the reference datasets via Spearman's rank correlation coefficient. The spearman correlation coefficient is defined as the Pearson correlation coefficient between the ranked variables. In Spearman's rank correlation coefficient, for a sample of size n, the n raw scores Xᵢ, Yᵢ are converted to ranks rgXᵢ, rgYᵢ. The spearman correlation coefficient is computed from the formula (2) below:

$${r}_{s} = {ρ}_{rgX , rgY} = \frac{cov ( rgX , rgY )}{{σ}_{rgX} {σ}_{rgY}} \qquad ( 2 )$$

Spearman's rank correlation coefficient assesses how well the relationship between two variables can be described using a monotonic function. If there are no repeated data values, a perfect Spearman correlation of +1 or −1 occurs when each of the variables is a perfect monotone function of the other.

In formula (2), ρ demotes the usual Pearson correlation coefficient, but applied to the rank variables; cove (rgX, rgY) is the covariance of the rank variables; and σ_{rgX} and σ_{rgY} are the standard deviations of the rank variables. The sign of the Spearman correlation indicates the direction of association between X (the predictor variable) and Y (the response variable). If Y tends to increase when X increases, the Spearman correlation coefficient is positive. If Y tends to decrease when X increases, the Spearman correlation coefficient is negative. A Spearman correlation of zero indicates that there is no tendency for Y to either increase or decrease when X increases. The Spearman correlation increases in magnitude as X and Y become closer to being perfect monotone functions of each other. When X and Y are perfectly monotonically related, the correlation coefficient becomes 1.

Returning to FIG. 2, in some embodiments, the environment 200 may further include an optimization component 250. After the comparison component 220 determines the acceptably similar reference dataset and retrieves at least one of the estimated effective regression techniques corresponding to the acceptably similar reference dataset against the user dataset 230, the optimization component 250 may further optimize at least one of the retrieved regression techniques by tuning at least one of the hyperparameters.

In machine learning, hyperparameters are parameters whose values are set prior to the commencement of the learning process. By contrast, the model parameters are derived via learning. For instance, model parameters get adjusted by training with existing data, and hyperparameters are variables about the training process itself. Here, hyperparameter optimization is to choose a set of effective hyperparameters for the retrieved regression technique to optimize its performance on the user dataset 230. The measure of the performance may be but is not limited to the error metric and the training time limit.

There are also several methods for hyperparameter optimization, including but not limited to Bayesian optimization, grid search, random search, gradient-based optimization. In some embodiments, the system optimizes the hyperparameters of the retrieved regression techniques using Bayesian optimization.

Bayesian optimization treats the objective function as a random function that has a normal (Gaussian) distribution. It gathers the function evaluations. The gathered function evaluations are treated as data to form the normal distribution over the objective function. The formed distribution, in turn, is used to construct an acquisition function that determines what the next query point should be.

Examples of acquisition functions include probability of improvement, expected improvement, Bayesian expected losses, upper confidence bounds (UCB), Thompson sampling and mixtures of these. For instance, A is a regression technique whose hyperparameters p are being optimized. In one embodiment, the acquisition function is an error function. E_{best} is the best value of the error function. f(A(p)) is the error function value evaluated for regression technique A and hyperparameters p. To evaluate the error function for hyperparameters p, the error improvement function is:

Eᵢₘₚ(p)=max{0,e_{best}−f(A(p))} (3)

The above formula (3) defines how to calculate error improvement for every hyperparameter configuration. Assuming the error improvement is sampled from Gaussian process G(u′, K). u′ is the mean function and K is the covariance function. u′ and K determine the Gaussian process. Based on this assumption, the closed function formula is:

$$\begin{matrix}EI ( p ) = σ ( p ; ( {p}_{1} , … , {p}_{n} ) , ⊖ ) ( ϒ ( p ) φ ( ϒ ( p ) ) + N ( ϒ ( p ) ) ) & ( 4 ) \\ ϒ ( p ) = \frac{{e}_{best} - {u}^{′} ( p ; \{ {p}_{1} , … {p}_{n} \} , θ )}{σ ( p ; \{ {p}_{1} , … {p}_{n} \} , θ )} & ( 5 )\end{matrix}$$

p is the hyperparameters that are considered. p₁, . . . , pₙ are all hyperparameters for which we evaluated error function, θ is the Gaussian process parameter setting, they can be estimated using maximum likelihood method from all previous error function evaluations. σ(p; {p₁, . . . pₙ}, θ) is the predicated variance at setting p, and u′ (p; {p₁, . . . pₙ}, is the predicted value of mean function u′, ϕ and N are cumulative distribution function and probability distribution function of the standard normal distribution.

In another embodiment, the system may use expected error improvement as acquisition function in Bayesian optimization.

In another embodiment, the system may use expected error improvement over time as the acquisition function. Expected error improvement over time is expected error improvement divided by the estimated time needed to evaluate the error function, which aims to choose the hyperparameters that expect to yield greatest error improvement per unit of time. Such an acquisition function balances the accuracy and training time, returning hyperparameter settings that perform fairly fast and fairly accurate, but not the ones that perform the fastest or the most accurate. The system can set a default acquisition function. Alternatively, users can choose their preferred acquisition functions.

There are many choices of acquisition functions, including but not limited to expected error improvement and expected improvement over time, which provide users the flexibility to focus on pure accuracy or time-bounded accuracy. For instance, if a user chooses to focus on time budget, he may enter 120 seconds as the time limit. Accordingly, the program will aim to complete the hyperparameter optimization and produce the resulting model within 2 minutes. If the time limit is not supplied, a default value may be used, alternatively, no limit may be set, such that the time limit is infinity.

In another embodiment, the time limit may also include the time spent on dataset comparison. To avoid spending time budget completely on dataset comparison, the system may set a constraint, for instance 50% of the supplied time budget can be spent on dataset comparison. Often there may not be enough time to complete comparison between user's dataset to all reference datasets, but only to some of them. The constraint on dataset comparison may also correlate to the size of the user dataset and the time budget. When the data size is fairly large and the time budget is low, the system may designate a larger portion of the time budget to data comparison and less time to hyperparameter optimization and/or regression analysis.

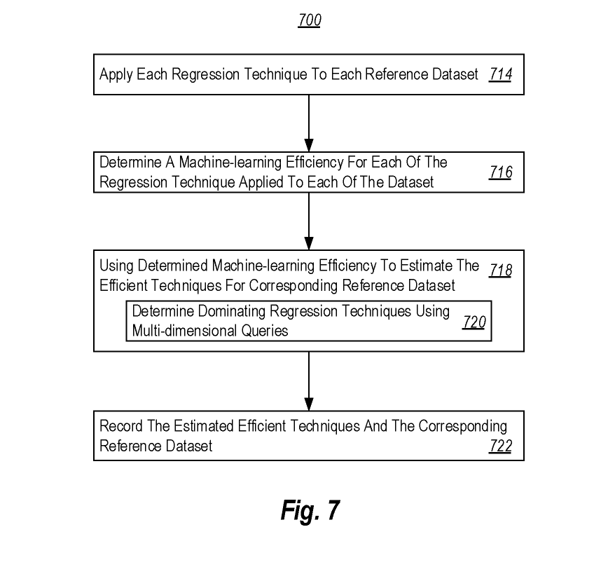

FIG. 7 illustrates a flowchart of an example method 700 for determining effective regression techniques for datasets. This method may be implemented via a computing system 100 illustrated in FIG. 1 or an executable component 106 running on that computing system 100. The computing system 100 has access to multiple reference datasets 710 and multiple regression techniques 712. The system applies each of the regression techniques 712 to each of the reference datasets 710 (act 714), and determines a machine-learning metric for each of the regression techniques 712 applied to each of the dataset (act 716). For each of the reference datasets 710, the computing system 100 uses the determined machine-learning metric to estimate one or more of the regression techniques as being effective amongst the regression techniques 712 for execution of the corresponding reference dataset (act 718). In some embodiments, the act of estimating one or more effective regression techniques (act 718) may include determining dominating regression techniques using multi-dimensional queries (act 720). After estimating the one or more effective regression techniques for each of the corresponding reference dataset (act 718), the system may record the one or more effective regression techniques and each of the corresponding reference dataset in the computer-readable media 104 of the computing system 100 (act 722).

The list of reference datasets (710) may be expanded to include more reference dataset (act 702), the list of regression techniques (712) may also be expanded to include more regression techniques (act 704). The system may also add more hyperparameters to one or more of the regression techniques (712) (act 706), and the system may also add more considerations to the machine-learning metric measurement (act 708), such that the method 700 is constantly optimized to reflect new reference datasets, newly developed regression techniques and/or user's preferred measurements of machine learning metric.

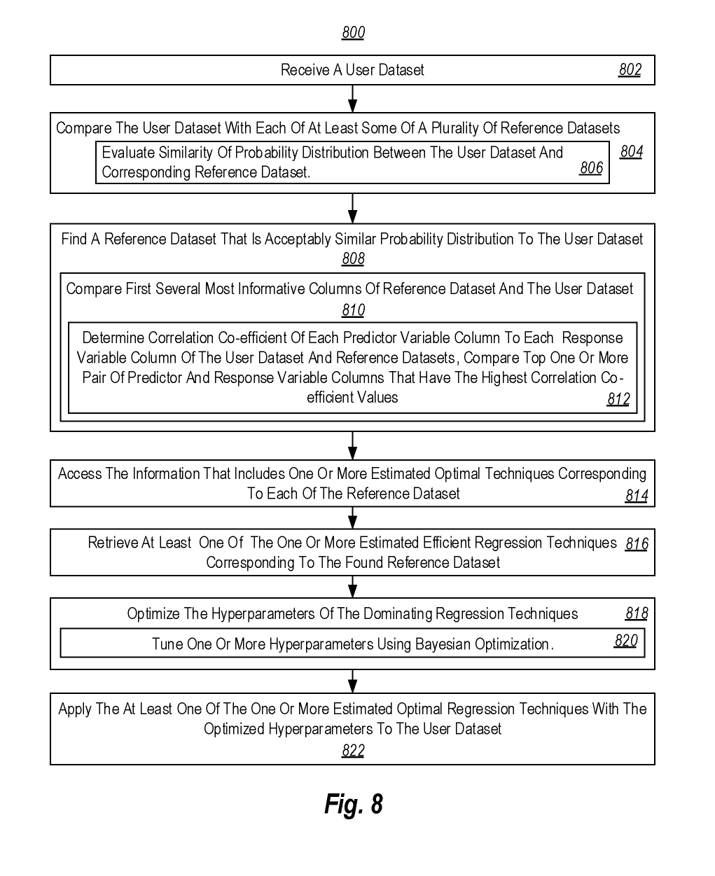

FIG. 8 illustrates a flowchart of an example method 800 for choosing effective regression techniques for a user dataset. The method 800 may also be implemented via a computing system 100 illustrated in FIG. 1 or an executable component 106 running on that computing system 100. The computing system used to implement method 800 and the computing system used to implement method 700 may be the same computing system. Alternatively, the computing system of the method 800 and the computing system of the method 700 may not be the same computing system.

In some embodiments, the computing system of method 700 is a server or a cloud computing system, and the computing system of method 800 is a client computing system. The client computing system has access to the server via computer network.

The computing system of method 800 also has access to multiple reference datasets, multiple regression techniques, and multiple considerations of machine-learning metric. The information that includes the one or more estimated effective techniques for each of the reference datasets. the multiple reference datasets, multiple regression techniques, multiple considerations of machine-learning metric, and the information that includes the one or more estimated effective techniques may be stored in the computing system of method 800. Alternatively, such information may also be stored in the computing system of 700, to which the computing system of 800 has access.

When a user initiates an analysis of a user dataset (act 802), the computing system compares the user dataset with at least some of the reference datasets (act 804). The act of comparing 804 may include an act of evaluating 806 the similarity of the probability distribution between the user dataset and some of the reference datasets. The act of comparing 804 may also include evaluating similarity of size and/or other characteristics of the user dataset and some of the reference datasets.

After the act of comparing 804 and evaluating 806, the system finds a reference dataset that is acceptable to the user dataset (act 808) based on the evaluation 806 of similarity of the probability distribution, size, and/or other characteristics between the user dataset and some of the reference datasets. In some embodiments, the act of finding 808 the acceptably similar reference dataset may include an act of comparing 810 the top one or more most informative columns of the user dataset and the reference dataset. In some embodiments, to determine which columns are the most informative columns may include determining the correlation co-efficient of each predictor variable column to each response variable column of the user and the reference datasets and comparing the top several pairs of predictor and response variable columns that have the highest correlation co-efficient values (act 812).

After finding the acceptably similar reference dataset (act 808), the system accesses the information that includes one or more estimated effective regression techniques for each corresponding reference dataset (act 814), and retrieves the one or more dominating regression techniques associated to the sufficient similar reference dataset (act 816).

The computing system may further optimize the hyperparameters of at least one of the retrieved effective regression techniques (act 818). In some embodiments, the act of optimizing the hyperparameters 818 may include tuning one or more hyperparameters using Bayesian optimization (act 820). Finally, the computing system applies at least one of the one or more estimated effective regression techniques with the optimized hyperparameters to the user dataset (act 822).

By comparing the user dataset to some of the reference datasets for finding an acceptably similar reference dataset to the user dataset, and retrieving at least one of the effective regression techniques of the acceptably similar reference dataset as an estimated effective regression technique for the user dataset, the user does not need to understand any technical background of machine learning or regression techniques or the process that the user dataset was generated. Additionally, computing the estimated effective regression techniques for each of the reference datasets beforehand reduces the computing time for analyzing the user dataset, because the user dataset does not need to be analyzed by multiple regression techniques to find an effective regression technique, but is only compared with some of the reference datasets.

Thus, an effective mechanism has been described for estimating an effective regression technique for a user dataset based on the effective regression techniques pre-determined for a reference dataset that is acceptably similar to the user dataset. The regression techniques' efficiency is measured by the machine-learning metric, which may include one or more considerations, including but not limited to machine-learning training time, accuracy, explainability and simplicity. The user can indicate the balance of each of the considerations of the machine-learning metric, such that the system estimates at least one effective regression technique that is likely to meet the user's needs.

Using the principles described herein, the user can rely on the computing system to estimate effective regression techniques based on the user's needs without additional research about the user dataset or available machine-learning or regression techniques.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon
computer-executable instructions that are structured such that, when executed by the one or more processors, cause the computing system to perform a method for estimating optimal regression techniques for datasets, the method comprising:
applying each of a plurality of regression techniques to each of a plurality of reference datasets;
determining a corresponding machine-learning metric for each of the regression techniques applied to each of the reference datasets; and
for each of the plurality of reference datasets,
using the determined machine-learning metric to estimate one or more of the plurality of regression techniques as being effective amongst the plurality of regression techniques for machine learning execution of the corresponding reference dataset; and
recording the estimated one or more effective regression techniques and the corresponding reference dataset in at least one of the one or more computer-readable media.

2. The computing system of claim 1, wherein the estimation of the one or more of the plurality of the regression techniques as being effective amongst the plurality of regression techniques comprises:
determining one or more dominating techniques using multi-dimensional selection queries.

3. The computing system of claim 1, wherein the corresponding machine-learning metric is determined using at least a training time of the regression technique.

4. The computing system of claim 1, wherein the corresponding machine-learning metric is determined using at least model accuracy of the regression technique.

5. The computing system of claim 1, wherein the corresponding machine-learning metric is determined using at least a resource usage of the regression technique.

6. The computing system of claim 1, wherein the corresponding machine-learning metric is determined using at least an explainability of the regression technique.

7. The computing system of claim, wherein the corresponding machine-learning metric is determined using at least a simplicity of the regression technique.

8. A method for estimating effective regression techniques for datasets, using a computing device that includes one or more processors; and one or more computer-readable media having thereon computer-executable instructions that are structured such that, when executed by the one or more processors, cause the computing device to perform the method, the method comprising:
applying each of a plurality of regression techniques to each of a plurality of reference datasets;
determining a corresponding machine-learning metric for each of the regression techniques applied to each of the reference datasets; and
for each of the plurality of reference datasets,
using the determined machine-learning metric to estimate one or more of the regression techniques as being optimal amongst the plurality of regression techniques for execution of the corresponding reference dataset, and
recording the estimated one or more optimal regression techniques and the corresponding reference dataset.

9. The method of claim 8, wherein estimation of the one or more of the regression techniques as being effective amongst the plurality of regression techniques comprises:
determining one or more dominating techniques using multi-dimensional queries.

10. The method of claim 8, wherein the machine learning metric is determined using at least a training time of the regression technique.

11. The method of claim 8, wherein the machine learning metric is determined using at least model accuracy of the regression technique.

12. The method of claim 8, wherein the machine learning metric is determined using at least an explainability of the regression technique.

13. The method of claim 8, wherein the machine learning metric is determined using at least a simplicity of the regression technique.

14. A computing system comprising:
one or more processors; and
one or more computer-readable media having thereon:
computer-executable instructions that are structured such that, when executed by the one or more processors, cause the computing system to perform a method for choosing effective regression techniques for a user dataset, the method comprising:
receiving a user dataset;
comparing the user dataset with each of at least some of a plurality of reference datasets, the comparing comprising the following for each of the reference data sets: evaluating similarity of probability distribution between the user dataset and the corresponding reference dataset;
finding a reference dataset that has an acceptably similar probability distribution to the user dataset;
accessing at least one of the one or more computer-readable media that includes one or more estimated effective regression techniques corresponding to each of the plurality of reference datasets;
retrieving at least one of the one or more estimated effective regression techniques corresponding to the found acceptably similar reference dataset; and
applying the at least one of the one or more estimated effective regression techniques to the user dataset.

15. The computing system of claim 14, wherein the one or more regression techniques that are estimated as the effective regression techniques corresponding to the found acceptably similar reference dataset comprise one or more dominating regression techniques that are determined using multi-dimensional selection queries.

16. The computing system of claim 14, wherein evaluating similarity of probability distribution between the user dataset and the corresponding reference dataset comprises:
determining that one or more columns of the user dataset are the most informative pair(s) of columns of the user dataset;
determining that one or more columns of the corresponding reference dataset are the most informative columns of the corresponding reference dataset; and
evaluating the similarity of the probability distribution between the one or more pair of the most informative columns of the user dataset and each of the one or more most informative columns of the corresponding reference datasets.

17. The computing system of claim 16, wherein the user dataset includes one or more predictor variable columns and one or more response variable columns, and each of the plurality of reference dataset includes one or more predictor variable columns and one or more response variable columns;
wherein the determining that one or more columns of the user dataset are the most informative columns of the user dataset comprises:
determining a correlation co-efficient between each predictor variable column and each response variable column of the user dataset; and
selecting the top one or more pair(s) of predictor variable column and response variable column that have the highest correlation co-efficient as the most informative pair(s) of columns of the user dataset;
wherein the determining that one or more columns of the corresponding reference datasets as being the most informative columns of the corresponding reference dataset comprises:
determining a correlation co-efficient between each predictor variable column and each response variable column of the corresponding reference datasets; and
selecting the top one or more pair(s) of predictor variable column and response variable column that have the highest correlation co-efficient as the most informative pair(s) of columns of the corresponding reference dataset;
wherein evaluating similarity of probability distribution between the user dataset and the corresponding reference dataset comprises:
estimating the probability distribution for each of the selected most informative pair(s) of columns of the user dataset;
estimating the probability distribution for each of the selected most informative pair(s) of columns of the corresponding reference dataset; and
determining the similarity between the estimated probability distribution for each of the selected most informative pair(s) of columns of the user dataset and the estimated probability distribution of each of the selected most informative pair(s) of columns of the corresponding dataset.

18. The computing system of claim 14, wherein the at least one retrieved regression technique includes one or more hyperparameters, and
the method further comprises:
optimizing the one or more hyperparameters.

19. The computing system of claim 18, wherein optimizing the hyperparameters includes tuning one or more hyperparameters to enable a tradeoff between training time and model accuracy.

20. The computing system of claim 19, wherein tuning one or more hyperparameters uses Bayesian optimization.
